(19) United States
(12) Patent Application Publication
(10) Pub. No.: US 2012/0316976 A1
(43) Pub. Date: Dec. 13, 2012

(54) TRANSACTION CARD PROCESSING SYSTEM AND METHOD

(75) Inventor: Robert DYKES, San Jose, CA (US)

(73) Assignee: VERIFONE INC., San Jose, CA (US)

(21) Appl. No.: 13/156,934

(22) Filed: Jun. 9, 2011

(51) Int. Cl. G06Q 20/00

(52) U.S. Cl. 705/17

(57) ABSTRACT

A transaction card processing system including at least one server, at least one point of sale device for processing transactions using a transaction card and a database storing processing fee information for various categories of transaction cards, at least one of the at least one server and the at least one point of sale device being responsive to entry of a transaction card identifier via one of the at least one point of sale device for ascertaining processing fee information for the transaction card by accessing the database and for ascertaining whether the processing fee information exceeds a predetermined threshold and in the event of exceedance of the threshold to cause the point of sale device at which the entry took place to provide a notification responsive to the exceedance.

### FIELD OF THE INVENTION

The present invention relates to transaction card processing systems and methodologies generally.

### BACKGROUND OF THE INVENTION

The following publication appears to represent the current state of the art:

Article Entitled “INTERCHANGE FEE” downloaded from Wikipedia on Apr. 28, 2011.

### SUMMARY OF THE INVENTION

The present invention seeks to provide improved transaction card processing systems and methodologies.

There is thus provided in accordance with a preferred embodiment of the present invention a transaction card processing system including at least one server, at least one point of sale device for processing transactions using a transaction card and a database storing processing fee information for various categories of transaction cards, at least one of the at least one server and the at least one point of sale device being responsive to entry of a transaction card identifier via one of the at least one point of sale device for ascertaining processing fee information for the transaction card by accessing the database and for ascertaining whether the processing fee information exceeds a predetermined threshold and in the event of exceedance of the threshold to cause the point of sale device at which the entry took place to provide a notification responsive to the exceedance.

Preferably, the database is associated with the at least one server.

There is also provided in accordance with another preferred embodiment of the present invention a transaction card processing method including processing transactions using a transaction card by employing at least one point of sale device, storing in a database processing fee information for various categories of transaction cards and responsive to entry of a transaction card identifier via one of the at least one point of sale device ascertaining processing fee information for the transaction card by accessing the database, ascertaining whether the processing fee information exceeds a predetermined threshold and in the event of exceedance of the threshold causing the point of sale device at which the entry took place to provide a notification responsive to the exceedance.

Preferably, the database is associated with at least one server involved in processing a proposed transaction.

Preferably, the processing fee information includes an interchange rate applicable to a given transaction.

In accordance with a preferred embodiment of the present invention the predetermined threshold associated with the at least one point of sale device is selected by a merchant operating the at least one point of sale device. Preferably, the at least one point of sale device includes a plurality of point of sale devices and the predetermined threshold differs for at least two of the plurality of point of sale devices. In accordance with a preferred embodiment of the present invention the predetermined threshold differs for different products purchased via the at least one point of sale device.

In accordance with a preferred embodiment of the present invention, the database is associated with the at least one point of sale device.

In accordance with a preferred embodiment of the present invention the point of sale device is responsive to exceedance of the predetermined threshold not to proceed with a proposed transaction unless overridden.

Preferably, the notification includes a user-selectable override option enabling a merchant to proceed with a transaction notwithstanding exceedance of the predetermined threshold.

In accordance with a preferred embodiment of the present invention the database employs an updated external source of processing fee information.

### BRIEF DESCRIPTION OF THE DRAWINGS

The present invention will be understood and appreciated from the following detailed description, taken in conjunction with the drawings in which:

FIG. 1 is a simplified pictorial illustration of the operation of a transaction card processing system and methodology in accordance with a preferred embodiment of the present invention;

FIG. 2 is a simplified block diagram of a transaction card processing system constructed and operative in accordance with a preferred embodiment of the present invention; and

FIG. 3 is a simplified flow chart illustrating the operation of the transaction card processing system of FIG. 2.

### DETAILED DESCRIPTION OF A PREFERRED EMBODIMENT

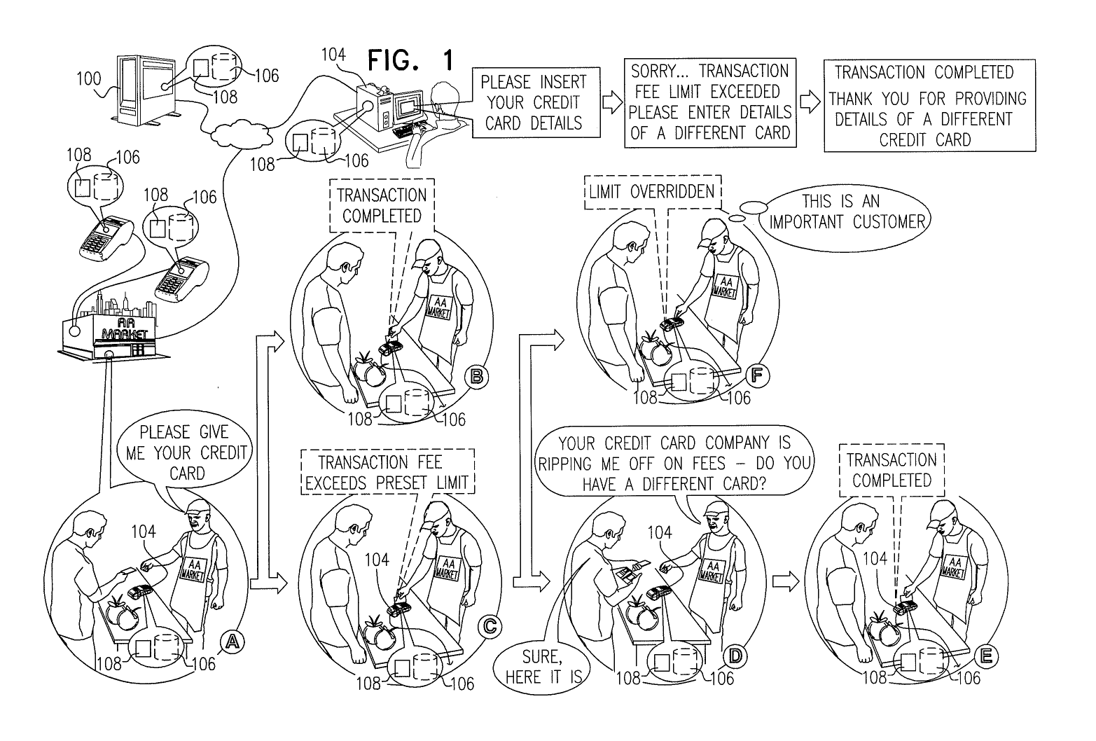

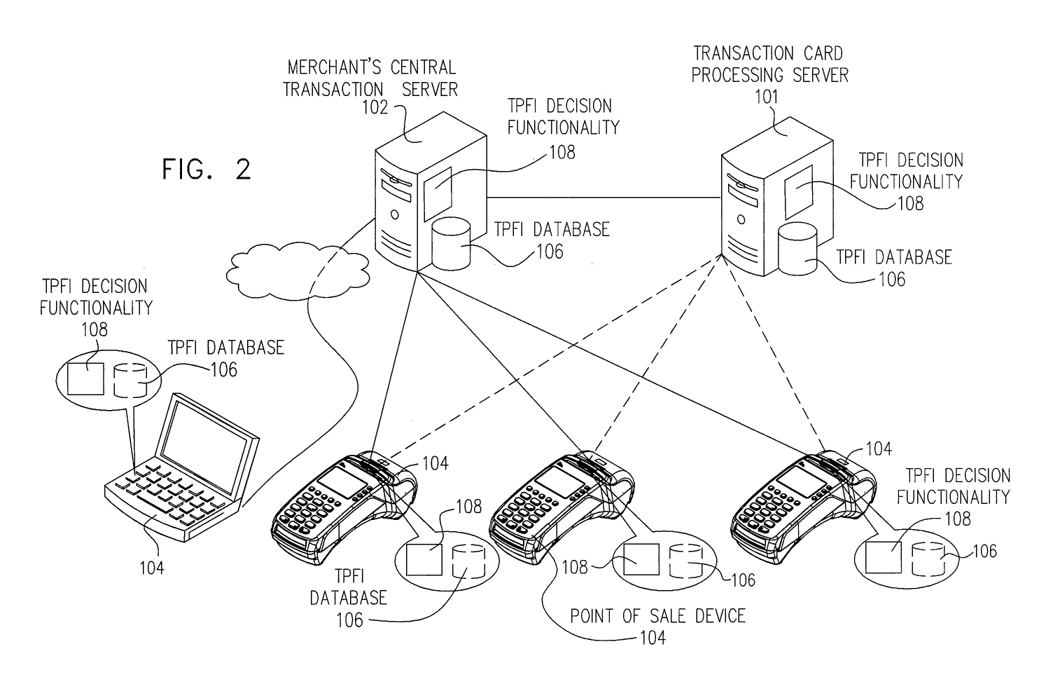

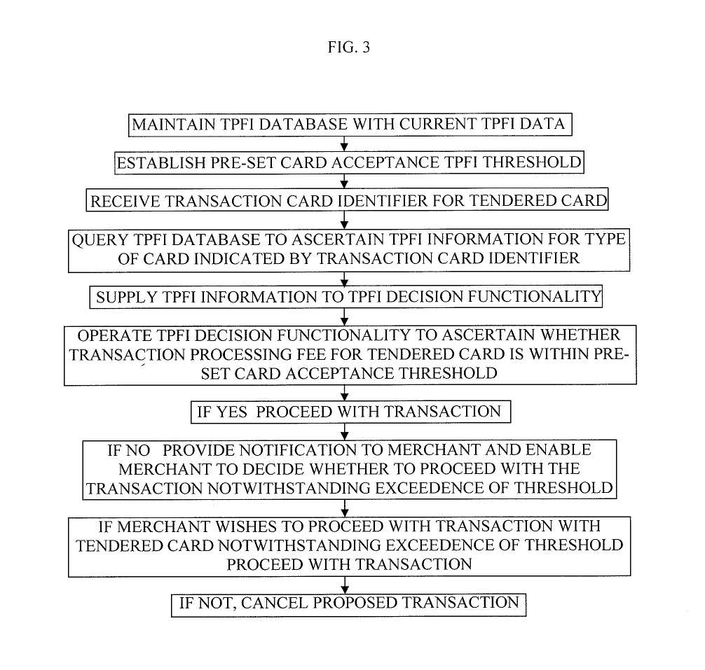

Reference is now made to FIGS. 1-3, which illustrate the structure and operation of a transaction card processing system, constructed and operative in accordance with a preferred embodiment of the present invention.

The transaction card processing system of the present invention preferably includes at least one server 100. The at least one server may be, for example, a transaction card processing server 101, such as a credit/debit card processing server, or a merchant's central transaction server 102. A plurality of point of sale devices 104 may be associated with either of servers 101 and 102, for processing transactions using a transaction card. The point of sale devices 104 may include, for example, cash registers, credit card acceptors and PIN pads, as well as client-based internet communicators, via which purchases may be made on the internet.

In accordance with a preferred embodiment of the present invention, at least one transaction processing fee information (TPFI) database 106 is provided for storing transaction processing fee information for various categories of transaction cards, typically credit cards of various issuers which have differing processing fees for various categories of transactions. A TPFI database 106 may be associated with either or both of servers 101 and 102. Alternatively or additionally, a TPFI database 106 may be incorporated in one or more of the point of sale devices 104. The TPFI database 106 is preferably automatically updated to reflect current TPFI data. External sources of TPFI information may be employed for this purpose.

As depicted particularly in FIG. 1, at view A, a customer making a purchase presents a credit card which is swiped at a point of sale device 104, to enter a transaction card identifier, such as a credit card number, into the system. Either the point of sale device 104 or one of servers 101 and 102 automatically queries a database 106 associated therewith, in order to ascertain the transaction processing fee information relating to the specific card presented by the customer. The transaction processing fee information typically includes the amount of an interchange rate and may also include other rates or fees which are chargeable to the merchant. The terms “rate” and “fee” are used interchangeably throughout for the sake of conciseness.

It is appreciated that the system and functionality of the present invention, as depicted in FIGS. 1-3, applies not only to card-present transactions, where the card-bearing customer is present at the merchant's premises, but also to card-not-present transactions, such as transactions carried out via the internet using client-based internet communicators, which serve as point of sale devices 104.

TPFI decision functionality 108, which may be located either at a point of sale device 104 or at either of servers 101 and 102, receives the transaction processing fee information from the database 106 and compares it with a pre-set card acceptance threshold. The card acceptance threshold is typically set by the merchant. Various thresholds may be set for various point of sale devices operated by a single merchant and various thresholds can be set for various types of products purchased. Thus a higher threshold may apply to a purchase of a high profit margin item.

If the transaction processing fee for the proposed transaction is within the acceptable threshold limits pre-set by the merchant, the transaction is completed in the normal course, as shown in view B. However, if the transaction processing fee exceeds the pre-set threshold limits, a notification is provided to the merchant via the point of sale device 104, as seen in view C. A typical notification, which could appear on the screen of a point of sale device, would be “TRANSACTION FEE EXCEEDS PRE-SET LIMIT”. This notification may be accompanied, for example, by an instruction such as: “TO OVERRIDE, PRESS ESCAPE.” In such a case, the transaction is not completed at this stage.

The merchant may approach the customer and request the use of an alternative credit card having lower transaction processing fees, as shown in view D. If the alternative credit card has transaction fees that do not exceed the preset limit, the transaction is completed, as shown at view E. Alternatively, the merchant may decide to ignore the limit for the given customer or transaction and override the TPFI decision functionality, thereby allowing the transaction to proceed to completion as shown in view F.

It will be appreciated by persons skilled in the art that the present invention is not limited to what has been particularly shown and described hereinabove. Rather, the scope of the invention includes both combinations and subcombinations of the various features described hereinabove and modifications thereof which are not in the prior art.

1. A transaction card processing system comprising:
at least one server;
at least one point of sale device for processing transactions using a transaction card; and
a database storing processing fee information for various categories of transaction cards,
at least one of said at least one server and said at least one point of sale device being responsive to entry of a transaction card identifier via one of said at least one point of sale device for ascertaining processing fee information for said transaction card by accessing said database and for ascertaining whether said processing fee information exceeds a predetermined threshold and in the event of exceedance of said threshold to cause said point of sale device at which said entry took place to provide a notification responsive to said exceedance.

2. A transaction card processing system according to claim 1 and wherein said processing fee information includes an interchange rate applicable to a given transaction.

3. A transaction card processing system according to claim 1 and wherein said predetermined threshold associated with said at least one point of sale device is selected by a merchant operating said at least one point of sale device.

4. A transaction card processing system according to claim 3 and wherein said at least one point of sale device comprises a plurality of point of sale devices and said predetermined threshold differs for at least two of said plurality of point of sale devices.

5. A transaction card processing system according to claim 3 and wherein said predetermined threshold differs for different products purchased via said at least one point of sale device.

6. A transaction card processing system according to claim 1 and wherein said database is associated with said at least one server.

7. A transaction card processing system according to claim 1 and wherein said database is associated with said at least one point of sale device.

8. A transaction card processing system according to claim 1 and wherein said point of sale device is responsive to exceedance of said predetermined threshold not to proceed with a proposed transaction unless overridden.

9. A transaction card processing system according to claim 1 and wherein said notification includes a user-selectable override option enabling a merchant to proceed with a transaction notwithstanding exceedance of said predetermined threshold.

10. A transaction card processing system according to claim 1 and wherein said database employs an updated external source of processing fee information.

11. A transaction card processing method comprising:
processing transactions using a transaction card by employing at least one point of sale device;
storing in a database processing fee information for various categories of transaction cards; and
responsive to entry of a transaction card identifier via one of said at least one point of sale device:
ascertaining processing fee information for said transaction card by accessing said database;
ascertaining whether said processing fee information exceeds a predetermined threshold; and
in the event of exceedance of said threshold causing said point of sale device at which said entry took place to provide a notification responsive to said exceedance.

12. A transaction card processing method according to claim 11 and wherein said processing fee information includes an interchange rate applicable to a given transaction.

13. A transaction card processing method according to claim 11 and wherein said predetermined threshold associated with said at least one point of sale device is selected by a merchant operating said at least one point of sale device.

14. A transaction card processing method according to claim 13 and wherein said at least one point of sale device comprises a plurality of point of sale devices and said predetermined threshold differs for at least two of said plurality of point of sale devices.

15. A transaction card processing method according to claim 13 and wherein said predetermined threshold differs for different products purchased via said at least one point of sale device.

16. A transaction card processing method according to claim 11 and wherein said database is associated with at least one server involved in processing a proposed transaction.

17. A transaction card processing method according to claim 11 and wherein said database is associated with said at least one point of sale device.

18. A transaction card processing method according to claim 11 and wherein said point of sale device is responsive to exceedance of said predetermined threshold not to proceed with a proposed transaction unless overridden.

19. A transaction card processing method according to claim 11 and wherein said notification includes a user-selectable override option enabling a merchant to proceed with a transaction notwithstanding exceedance of said predetermined threshold.

20. A transaction card processing method according to claim 11 and wherein said database employs an updated external source of processing fee information.
